(19) United States
(12) Patent Application Publication
(10) Pub. No.: US 2012/0209872 A1
(43) Pub. Date: Aug. 16, 2012

(54) USER-CENTRIC IDENTITY MANAGEMENT PROXY FOR PERSONALIZED BROWSING

(75) Inventors: Colin Woods, Dunngannon (GB); Rajalakshmi Iyer, Belfast (GB)

(73) Assignee: OPENWAVE SYSTEMS INC., Redwood City, CA (US)

(21) Appl. No.: 13/026,265

(22) Filed: Feb. 13, 2011

(51) Int. Cl. G06F 17/30

(52) U.S. Cl. 707/769; 707/E17.014

(57) ABSTRACT

A user-centric identity management proxy system, including: a personalization engine configured to: receive user-centric information for a user from an identity management engine, wherein the user-centric information identifies the user and is specific to the user; receive context information for a location request by a user device from a content categorization engine, wherein the context information provides detail about the location request that is relatable to the user-centric information; and produce personalized information for the user based on the user-centric information and the context information; and a memory device to store the personalized information.

### BACKGROUND

Mobile device and digital communication technologies are improving, and the role that mobile devices play in everyday life is increasing. Consumers frequently use mobile devices having Internet connection capabilities for Internet browsing, emailing, scheduling, and the like. Online services attempting to provide individualized services for consumers often require consumers to provide login information.

The number of different online services that consumers subscribe to may be large, so consumers may have difficulty remembering the login information for each different service. Additionally, the services may provide incentives or rewards that users can receive by using the services, or even just by obtaining an account with a service. The large amount of information pertaining to a specific user for all of the services can be overwhelming and difficult to remember or organize.

### SUMMARY

Embodiments of a system are described. In one embodiment, the system is a user-centric identity management proxy system. The system includes: a personalization engine configured to: receive user-centric information for a user from an identity management engine, wherein the user-centric information identifies the user and is specific to the user; receive context information for a location request by a user device from a content categorization engine, wherein the context information provides detail about the location request that is relatable to the user-centric information; and produce personalized information for the user based on the user-centric information and the context information; and a memory device to store the personalized information. Other embodiments of the system are also described.

Embodiments of a computer program product and a method are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a user-centric identity management proxy system.

FIG. 2 depicts a schematic diagram of one embodiment of the mobile access gateway of FIG. 1.

FIG. 3 depicts a schematic diagram of one embodiment of personalized information inserted into a browser.

FIG. 4 depicts a schematic diagram of one embodiment of the mobile access gateway of FIG. 1 retrieving user-centric information.

FIG. 5 depicts a flow chart diagram of one embodiment of a method for personalized browsing.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a user-centric identity management proxy for providing personalized browsing. More specifically, embodiments are described that present a mobile access gateway capable of providing personalized information to a user on a mobile device. The gateway presents personalized information to the user device based on user-centric information and location context information provided for the user device.

The next-generation identity management paradigm (also referred to as Identity 2.0 or “user-centric” identity) allows consumers to have more control over their own information. Additionally, the increased use and capabilities of mobile devices makes it possible to provide more personalized services to consumers, including personalized browsing for a user. Implementing a personalized information system based on user-centric information and context at a gateway between a user device and an Internet connection may allow for uniform personalization to all subscribers or users of the gateway.

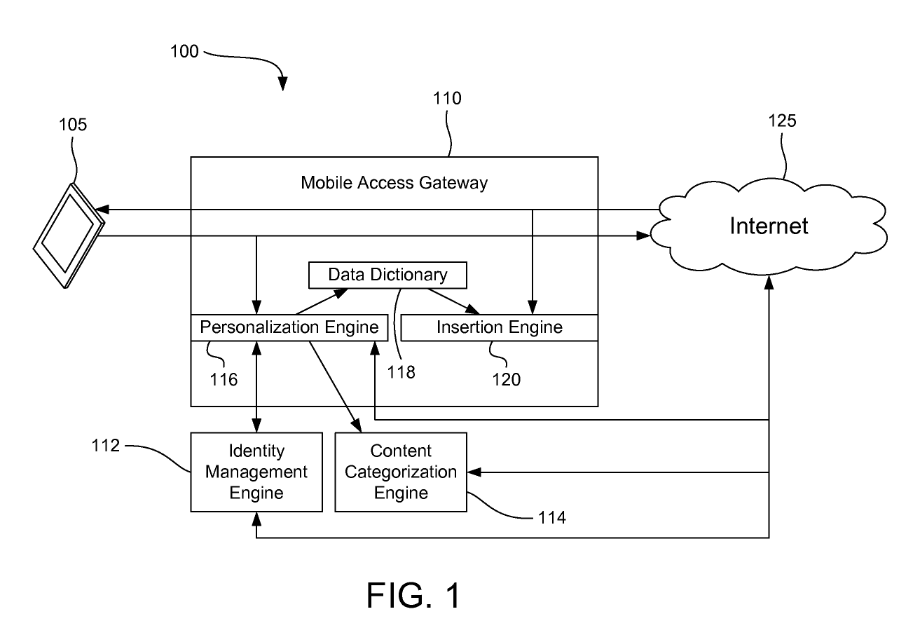

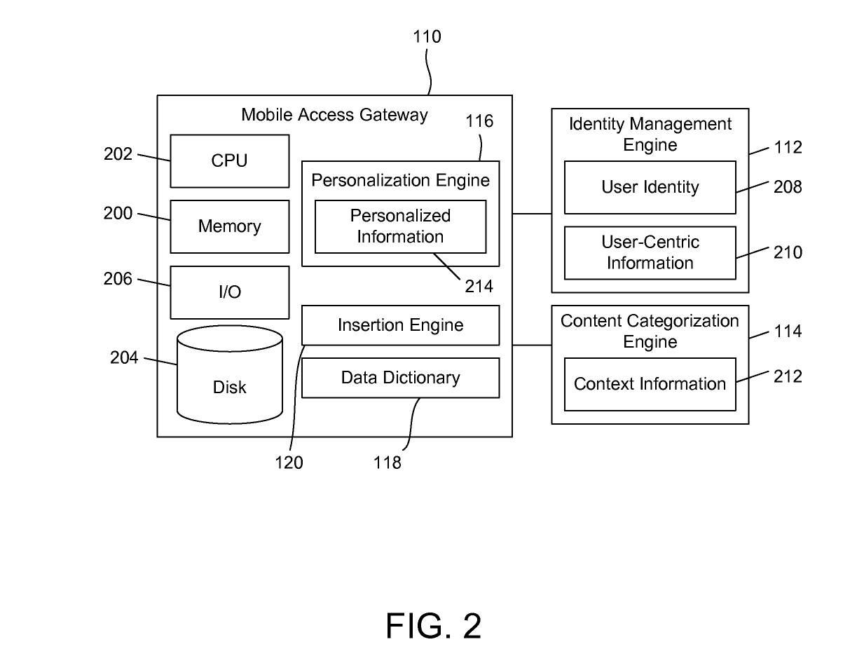

FIG. 1 depicts a schematic diagram of one embodiment of a user-centric identity management proxy system 100. The illustrated identity management proxy system 100 includes a mobile user device 105, a mobile access gateway 110, and a connection to the Internet 125. As further described in FIG. 2, the illustrated mobile access gateway 110 includes a personalization engine 116, a data dictionary 118, and an insertion engine 120, and is connected to an identity management engine 112 and a content categorization engine 114. Although the identity management proxy system 100 is shown and described with certain components and functionality, other embodiments of the identity management proxy system 100 may include fewer or more components to implement less or more functionality. In some embodiments, the identity management engine 112 and content categorization engine 114 may be integrated as part of the identity management proxy system 100.

The mobile access gateway 110 is an access point between the user device 105 and the Internet 125. As an access point, the gateway 110 may be a proxy for the user device 105 in a network. In one embodiment, the user device 105 is a mobile phone on a mobile network that allows the user to access the Internet 125 for browsing, email, etc., as well as placing calls and texting. The gateway 110 may handle all data traffic from the user device 105, and may thus monitor, add to, block, or otherwise alter data passing through the gateway 110. By leveraging these capabilities and information for the user device 105, the gateway 110 is able to provide personalized information to the user device 105.

In order to provide personalized browsing as described herein, the gateway 110 is connected to an identity management engine 112 and a content categorization engine 114. In one embodiment, the identity management engine 112 identifies a user based on the user device 105. While desktop computers are generally only identifiable through an Internet Protocol (IP) address, mobile devices (such as cell phones) are often identifiable to a particular user through an account with a mobile network. Because mobile devices are often tied directly to an identifiable user, the identity management engine 112 in a mobile access gateway is able to determine the identity of the user for a particular user device 105 for use in a personalized browsing system.

The identity management proxy system 100 receives user-centric information for the user associated with the user device 105 from the identity management engine 112. The identity management device 112 may retrieve the user-centric information from the user device 105 or from other sources, such as through a connection to the Internet 125. The user-centric information includes information relevant to the specific user that may be helpful in customizing information presented to the user while browsing the Internet 125 or according to a physical location of the user device 105, such as login information for websites, information stored in user profiles on the user device 105, remote devices, websites or other devices.

The gateway 110 is also connected to a content categorization engine 114 for providing context to the personalized browsing experience. The content categorization engine 114 obtains context information for a location request by the user device 105. The context information may include a categorization of the location that allows the gateway 110 to provide personalized information relevant to the category of the location. In one embodiment, the location request includes a request to connect to a particular website. The content categorization engine 114 may include a categorization database for websites to determine the category for the website in the location request based on a lookup of the uniform resource locator (URL) of the website in the database. The content categorization engine 114 may be connected to the Internet 125 to obtain the content category. In another embodiment, the location request includes a global positioning system (GPS) location of the current physical location of the user device. For GPS locations, the content categorization engine 114 may obtain the location category from a land map database having metadata for specified locations on the map. For example, the map database may include GPS locations for retail stores, and may assign categories to each retail store. In either the website scenario or the GPS scenario, the database may be a local database or a public database.

The mobile access gateway also includes a personalization engine 116. The personalization engine 116 combines the user-centric information received by the identity management engine 112 with the context information obtained by the content categorization engine 114 to produce personalized information for the user. After producing the personalized information, the gateway may store the personalized information in a data dictionary 118.

The gateway 110 also includes an insertion engine 120 for inserting the personalized information into display data for presentation at the user device 105. In one embodiment, the personalization process is performed when a user device 105 first makes a connection request to the gateway for a certain website. After producing the personalized information, the gateway inserts the information into the display data in a response to the user device 105.

For example, the user may use a mobile device to browse a certain website. Upon requesting to connect to the website or while browsing the website, the personalization engine 116 may determine that the context for the website is relevant to user-centric information received by the identity management engine 112 and produce a piece of personalized information from the relevant context and user-centric information. The personalized information is then stored in the data dictionary 118. In a response to the user device 105, the insertion engine 120 retrieves the stored personalized information from the data dictionary 118 and inserts the information into the data to be displayed at the user device 105 in the web browser.

In some embodiments, the information may be presented to the user as soon as the connection is established. In other embodiments, the gateway 110 may first establish a connection between the website and the user device 105 before performing some or all of the personalization actions, and may send a second response including the personalized information to the user device 105 after processing the personalized information.

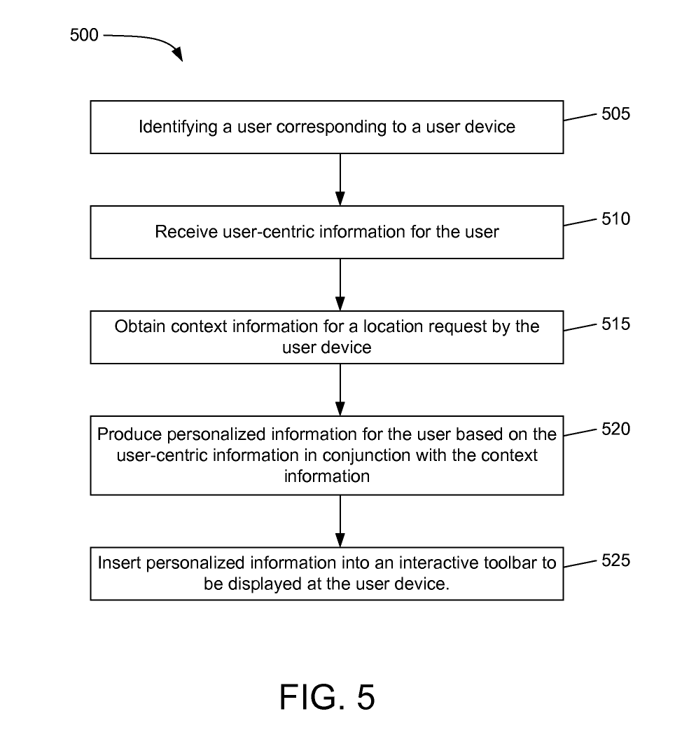

FIG. 2 depicts a schematic diagram of one embodiment of the mobile access gateway 110 of FIG. 1. The depicted mobile access gateway 110 includes various components, described in more detail below, that are capable of performing the functions and operations described herein. In one embodiment, at least some of the components of the mobile access gateway 110 are implemented in a computer system. For example, the functionality of one or more components of the mobile access gateway 110 may be implemented by computer program instructions stored on a computer memory device 200 and executed by a processing device 202 such as a central processing unit (CPU). The mobile access gateway 110 may include or be connected to other components, such as a disk storage drive 204, input/output devices 206, an identity management engine 112, a content categorization engine 114, a personalization engine 116, a data dictionary 118, an insertion engine 120, or others. Some or all of the components of the mobile access gateway 110 may be stored on a single computer or on a network of computers. The mobile access gateway 110 may include more or fewer components or modules than those depicted herein. In some embodiments, the mobile access gateway 110 may be used to implement the method described herein as depicted in FIG. 5.

The identity management engine 112 obtains a user identity 208 corresponding to a user device 105, such as a mobile phone. Based on that user identity 208, the identity management engine 112 retrieves user-centric information 210 for the user. In one embodiment, the user-centric information 210 is retrieved at the time a connection request is made by the user device 105 for a certain location. In another embodiment, the user-centric information 210 is periodically, automatically updated so that the personalization engine 116 may be able to produce the personalized information 214 faster.

The content categorization engine 114 obtains context information 212 for the location request by the user device 105. The context information 212 may include sufficient information (a website categorization, a GPS location categorization, etc.) related to the location to enable the personalization engine 116 to identify a relationship between the user-centric information 210 and the context information 212, such that the personalized information 214 presented to the user will be relevant and helpful to the user. The personalized information 214 produced by the personalization engine 116 is stored in the data dictionary 118. After the mobile access gateway 110 produces the personalized information 214, the insertion engine 120 retrieves the personalized information 214 from the data dictionary 118 and inserts the personalized information 214 in to a response to the user device 105.

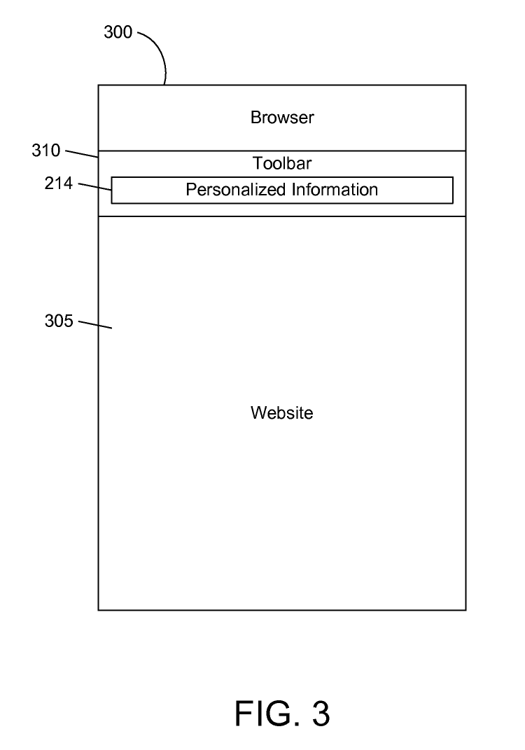

FIG. 3 depicts a schematic diagram of one embodiment of personalized information 214 inserted into a browser 300. The illustrated browser 300 may be a browser 300 on a mobile user device 105, such as a cell phone, that allows a user to browse the Internet 125 or communicate with a remote network. In one example of the system described herein, the user enters a URL for a website into the browser 300. The user device 105 sends a connection request to the mobile access gateway 110. The gateway 110 identifies the user based on the user device 105 and retrieves user-centric information 210 for the user. The gateway 110 also obtains the category for the URL entered and combines the context information 212 with the user-centric information 210 to produce personalized information 214 to be shown to the user. After producing the personalized information 214 and connecting to the website 305, the gateway 110 bundles the personalized information 214 with the data from the website 305 and sends all data to the user device 105 for viewing by the user. The personalized information 214 is produced when the user device 105 attempts to connect to the website 305; thus the personalized information 214 is specific to the website being viewed—i.e. the personalized information 214 is contextual to what the user is viewing.

In one embodiment, the personalized information 214 is presented in a JavaScript toolbar 310 in the browser at the user device 105. The toolbar data is sent with the website data, but as a separate piece of data. This allows the gateway 110 to insert the information into the response to the user device 105 without modifying the website data. In one embodiment, when being displayed on the user device 105, the toolbar 310 is positioned over a portion of the website view. In another embodiment, the website view is modified to allow the toolbar 310 to be placed in the browser 300 without overlapping the website data.

In one embodiment, the toolbar 300 is interactive, such that the user may select options to customize the toolbar content or visual settings. The toolbar 310 may be positioned at any location within the browser 300, and the position may be manually changed by the user. A currently presented selection of content may be modified by the user. For example, if the user navigates to a website 305 for booking airplane tickets, the mobile access gateway 110 may produce and insert personalized information 214 into the toolbar 310 including rewards such as frequent flyer miles that the user has for one or more airlines. The toolbar 310 may present a portion of the data as a default option to the user. The user may select, through a dropdown menu or otherwise, to view other portions of the personalized information 214 within the toolbar 310. The toolbar 310 may allow the user to hide the information or the toolbar 310 altogether.

Although the personalized information 214 is depicted herein as being inserted into a toolbar 210, other media or methods of presenting the information to the user at the user device 105 may be used to present the personalized information 214. The user device 105 may also allow the user to further personalize the displayed information, or send preferences to the mobile access gateway 110 to notify the gateway 110 how to better personalize the information in the future.

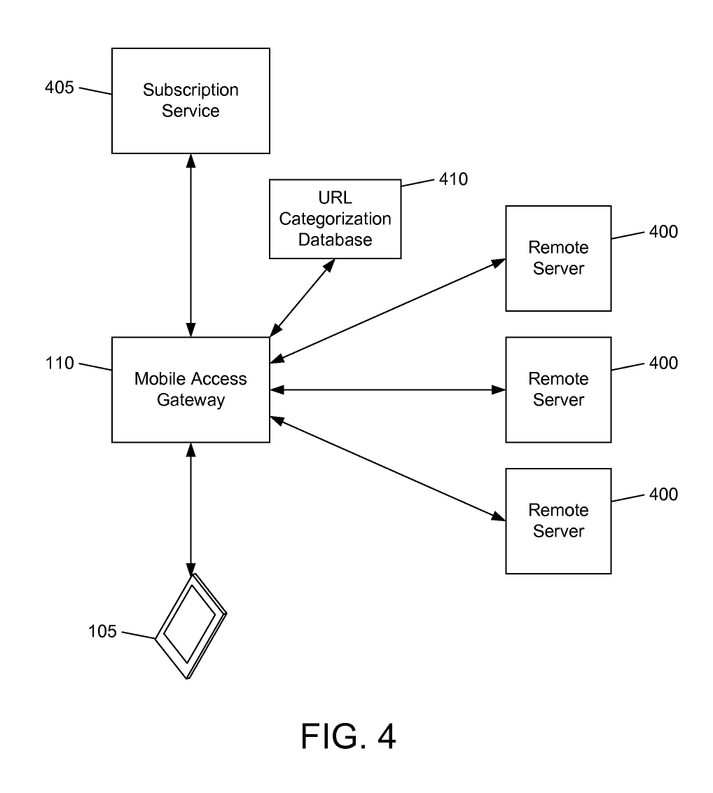

FIG. 4 depicts a schematic diagram of one embodiment of the mobile access gateway 110 of FIG. 1 retrieving user-centric information 210. In one embodiment, the mobile access gateway 110 retrieves the user-centric information 210 only from the user device. The user device 105 may have the necessary user-centric information 210 stored in a local cache that allows the mobile access gateway 110 effectively produce personalized information 214 for presentation at the user device 105.

In another embodiment, the mobile access gateway 110 retrieves user-centric information 210 from a source, including the user device 105, and retrieves additional data from one or more other sources, such as remote servers 405. The mobile access gateway 110 may obtain the context information 212 from a URL categorization database 410. The URL categorization database 410 may provide a category describing a website or other location from the location request. For example, the mobile access gateway 110 may contact servers belonging to services that the user has subscribed to or has accounts with. Returning to the frequent flyer miles example, when the user device 105 requests to connect with an airplane booking website, the gateway determines from the user device 105 or from information stored on the gateway 110 or other server that the user identified with the user device 105 has a profile with a certain airline website. The gateway 110 may contact the airline server and request information about the user's account. After the gateway 110 receives the account information from the airline server, the gateway 110 produces the personalized information 214 and sends it in a response to the user device 105.

In one embodiment, the gateway 110 retrieves or has access to digital identification cards through a subscription service 405 that the user enrolls in to allow the gateway 110 to provide the personalized information 214. The digital identification cards may contain user-centric information 210 for the user, including login information for certain websites. Consequently, when the user device 105 makes a connection request, the gateway 110 may obtain login information from the digital identification cards for other servers that are relevant to the connection request. The gateway 110 uses the login information to communicate with the relevant server and obtain additional user-centric information 210 and/or personalized information 214 for the user. The gateway may then produce/finalize the personalized information 214 and send it to the user device 105.

FIG. 5 depicts a flow chart diagram of one embodiment of a method 500 for personalized browsing. Although the method 500 is described in conjunction with the user-centric identity management proxy system 100 of FIG. 1, embodiments of the method 500 may be implemented with other types of identity management proxy systems 100.

The proxy system 100 first identifies 505 a user corresponding to a user device 105. Rather than being identified simply by an IP address, the user device 105 may be identified by a unique identifier that id directly tied to the user. This allows the proxy system 100 to accurately identify the user based solely on the user device 105, and does not require a manual identification from either the user or the proxy system.

After identifying 505 the user, the proxy system 100 is able to receive 510 user-centric information 210 for the user. In one embodiment, the user enrolls in a subscription service 405 for personalized browsing. The subscription service 405 may be offered by a service provider, such as a service provider that manages the mobile access gateway 110 for a cell phone network. Upon enrolling, the user agrees to share his digital identification cards with the service provider. The user device 105 may periodically synchronize with the subscription service 405 so that the subscription service has the most updated digital identification cards.

The gateway 110 then obtains 515 context information 212 for a location request by the user device 105. The request may occur when the user device 105 attempts to connect to a website or when the user enters a physical location whose GPS location is identified by a GPS locator. The context information 212 may include a category for the location; for example, the location may be categorized as a shopping website if the location request is for a website or as a shopping center if the location request is for a GPS location.

The gateway 110 then produces 520 personalized information 214 for the user based on the user-centric information 210 in conjunction with the context information 212, and inserts 525 the personalized information 214 into an interactive toolbar 310 to be displayed at the user device 105. The personalized information 214 may include any data relevant for the combination of context and user identity 208. For example, if the user visits a shopping website while browsing on the user device 105, the gateway 110 may retrieve all shopping identification cards for the user and logs onto the corresponding shopping sites to retrieve the relevant information, such as reward points or offers from the stores. In another embodiment, if the user enters a shopping center with the user device 105, the gateway 110 may use the GPS location to determine that the user is in a shopping center. The gateway 110 may send a notification to the user device 105 reminding the user to buy a certain product that the user had made a note to purchase. In this example, the gateway 110 may communicate with the user device to obtain user-centric information 210 from the user device 105, such as notes or reminders that the user entered into the user device 105.

An embodiment of a user-centric identity management proxy system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to provide personalized browsing for a user.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A user-centric identity management proxy system, comprising:
a personalization engine configured to:
receive user-centric information for a user from an identity management engine, wherein the user-centric information identifies the user and is specific to the user;
receive context information for a location request by a user device from a content categorization engine, wherein the context information provides detail about the location request that is relatable to the user-centric information; and
produce personalized information for the user based on the user-centric information and the context information; and
a memory device to store the personalized information.

2. The system of claim 1, further comprising an information insertion engine to insert the personalized information into display data in response to the location request by the user device.

3. The system of claim 2, wherein the display data is configured to implement an interactive toolbar to be displayed in a browser at the user device.

4. The system of claim 2, further comprising a data dictionary to interface between the personalization engine and the information insertion engine, wherein the data dictionary is configured to store the personalized information after the personalization engine produces the personalized information, wherein the information insertion engine is configured to retrieve the personalized information from the data dictionary and to populate the display data with the personalized information in response to the location request by the user device.

5. The system of claim 1, further comprising a subscription service to which the user subscribes, wherein the subscription service retrieves a digital identification card corresponding to the user for use by the identity management engine, wherein the digital identification card comprises user-centric information corresponding to a particular service.

6. The system of claim 1, wherein the content categorization engine comprises a uniform resource locator (URL) categorization database.

7. The system of claim 1, wherein the location request comprises information for a physical location of the user device.

8. A method for personalized browsing, comprising:
identifying a user corresponding to a user device;
receiving user-centric information for the user, wherein the user-centric information is specific to the user;
receiving context information for a location request by the user device, wherein the context information provides detail about the location request that is relatable to the user-centric information;
storing the user-centric information and the context information on a memory device; and
producing personalized information for a user based on the user-centric information and the context information.

9. The method of claim 8, further comprising inserting the personalized information into display data sent in response to the location request by the user device, wherein the display data is configured to implement an interactive toolbar to be displayed in a browser at the user device.

10. The method of claim 9, further comprising:
storing the personalized information in a data dictionary that interfaces between the personalization engine and the information insertion engine, wherein the personalized information is stored in the data dictionary after the personalization engine produces the personalized information; and
inserting the personalized information in response to the location request by the user device by retrieving the personalized information from the data dictionary and populating the display data with the personalized information.

11. The method of claim 8, further comprising:
enrolling the user in a subscription service; and
retrieving digital identification cards corresponding to the user, wherein the digital identification cards comprise user-centric information corresponding to a particular service.

12. The method of claim 8, further comprising periodically, automatically obtaining updated user-centric information for the user.

13. The method of claim 8, further comprising obtaining the context information for the location request from a uniform resource locator (URL) categorization database.

14. The method of claim 8, wherein the location request comprises information for a physical location of the user device.

15. A computer program product, comprising:
a computer readable storage device to store a computer readable program, wherein the computer readable program, when executed by a processor within a computer, causes the computer to perform operations for personalized browsing, the operations comprising:
identifying a user corresponding to a user device;
receiving user-centric information for the user, wherein the user-centric information is specific to the user;
receiving context information for a location request by the user device, wherein the context information provides detail about the location request that is relatable to the user-centric information;
storing the user-centric information and the context information on a memory device; and
producing personalized information for a user based on the user-centric information and the context information.

16. The computer program product of claim 15, wherein the computer program product, when executed on the computer, causes the computer to perform additional operations, comprising:
inserting the personalized information into display data sent in response to the location request by the user device, wherein the display data is configured to implement an interactive toolbar to be displayed in a browser at the user device.

17. The computer program product of claim 16, wherein the computer program product, when executed on the computer, causes the computer to perform additional operations, comprising:
storing the personalized information in a data dictionary that interfaces between the personalization engine and the information insertion engine, wherein the personalized information is stored in the data dictionary after the personalization engine produces the personalized information; and
inserting the personalized information in response to the location request by the user device by retrieving the personalized information from the data dictionary and populating the display data with the personalized information.

18. The computer program product of claim 15, wherein the computer program product, when executed on the computer, causes the computer to perform additional operations, comprising:
enrolling the user in a subscription service; and
retrieving digital identification cards corresponding to the user, wherein the digital identification cards comprise user-centric information corresponding to a particular service.

19. The computer program product of claim 15, wherein the computer program product, when executed on the computer, causes the computer to perform additional operations, comprising:
periodically, automatically obtaining updated user-centric information for the user.

20. The computer program product of claim 15, wherein the computer program product, when executed on the computer, causes the computer to perform additional operations, comprising:
obtaining the context information for the location request from a uniform resource locator (URL) categorization database.
